(19) United States
(12) Patent Application Publication
(10) Pub. No.: US 2010/0115680 A1
(43) Pub. Date: May 13, 2010

(54) Garment Including Electrical Energy Storage Unit

(76) Inventors: Toby D. Thomas, Southlake, TX (US); David L. Hoelscher, Arlington, TX (US)

Correspondence Address: DAVIS PATENT SERVICES, LLC, 9616 RAVENSWOOD RD., GRANBURY, TX, 76049, US

(21) Appl. No.: 12/595,404

(22) PCT Filed: Apr. 8, 2008
(86) PCT No.: PCT/US08/59684

§ 371 Date: Oct. 9, 2009

Related U.S. Application Data
(60) Provisional application No. 60/911,066, filed on Apr. 10, 2007.
(60) Provisional application No. 60/940,880, filed on May 30, 2007.

(51) Int. Cl. F41H 1/02; A41D 27/20; A41D 27/26; G08B 21/00

(52) U.S. Cl. 2/2.5; 2/247; 2/268; 340/636.1

(57) ABSTRACT

A body armor includes an armor plate, an electrical energy storage layer conforming to a surface of the armor plate, and a first electrical connector operably associated with the electrical energy storage layer. An armored garment includes a garment, an armor plate operably associated with the garment, an electrical energy storage layer conforming to a surface of the armor plate, and a first electrical connector operably associated with the electrical energy storage layer. A garment includes a body, a first pocket, and an electrical energy storage unit disposed in the first pocket.

### TECHNICAL FIELD

The present invention relates in general to the field of garments, including but not limited to utility garments, such as utility vests, and garments that incorporate body armor.

### DESCRIPTION OF THE PRIOR ART

Military and law enforcement personnel often carry battery-operated, portable electronic devices, such as communications equipment, global positioning satellite receivers, laser designators, night vision equipment, flashlights, rangefinders, and the like, while on patrol. Often, personnel carry several, if not many, such portable electronic devices. Batteries for portable electronic devices are either disposed within the devices or exist as dedicated battery packs. Typically, such portable electronic devices and battery packs are attached to belts worn by personnel or are disposed in pouches attached to belts worn by personnel.

If a battery of a portable electronic device, whether disposed within the device or existing as a separate battery pack, is struck by enemy fire, the portable electronic device is rendered inoperable. Moreover, such batteries add significant bulk to the devices that are carried by personnel. Conventional, portable electronic batteries and battery packs also add significant single-point weight loads that can be difficult for personnel to carry.

Utility garments, such as utility vests, are commonly used to hold equipment and supplies while personnel are working in the field. Conventional utility garments, however, suffer from several problems. For example, pockets of conventional utility garments are not configured to properly hold equipment needed in the field. Moreover, conventional utility garments fail to provide adequate power sources for powering field equipment. Furthermore, it is common for electrical power and communication cables that extend between various pieces of equipment to become entangled while in the field.

There are many articles of clothing well known in the art; however, considerable room for improvement remains.

### BRIEF DESCRIPTION OF THE DRAWINGS

The novel features believed characteristic of the invention are set forth in the appended claims. However, the invention itself, as well as a preferred mode of use, and further objectives and advantages thereof, will best be understood by reference to the following detailed description when read in conjunction with the accompanying drawings, in which the leftmost significant digit(s) in the reference numerals denote(s) the first figure in which the respective reference numerals appear, wherein:

FIG. 1 is a perspective view of an illustrative embodiment of a body armor having a conforming electrical energy storage unit that is operatively associated with a garment;

FIG. 2 is a stylized, cross-sectional view of a first illustrative embodiment of the body armor of FIG. 1 taken along the line 2-2 in FIG. 1;

FIG. 3 is a stylized, cross-sectional view of a second illustrative embodiment of the body armor of FIG. 1, corresponding to the view of FIG. 2;

FIG. 4 is a stylized, side, elevational view of an illustrative embodiment of the body armor of FIG. 1 having a plurality of electrical energy storage unit sections;

FIG. 5 is an enlarged view of an electrical connector of the body armor of FIG. 1;

FIG. 6 is a stylized, perspective view of illustrative embodiments of body armor used in various locations on a garment;

FIG. 7 is a front, perspective view of an illustrative embodiment of a utility garment;

FIG. 8 is a rear, perspective view of the utility garment embodiment of FIG. 7; and

FIG. 9 is a stylized, cross-sectional view of a cable tunnel of the utility garment of FIG. 7.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DESCRIPTION OF THE PREFERRED EMBODIMENT

Illustrative embodiments of the invention are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

The present invention relates to garments, such as utility garments and garments that include body armor. In one embodiment, a body armor having an electrical energy storage unit formed as a layer that substantially conforms to an armor plate. Preferably, the electrical energy storage layer conforms to an outer surface of the armor plate, i.e., the armor plate is disposed between the electrical energy storage layer and a person wearing the body armor when the body armor is in use. The body armor is particularly useful when operatively associated with a garment, such as a vest, that can be worn by a person. Preferably, the electrical energy storage layer comprises a plurality of sections so that, if one of the plurality of sections is damaged, the other sections of the plurality of sections remain operable. Two or more sections of the plurality of sections of the electrical energy storage layer may be electrically coupled, either in parallel or in series. The body armor includes one or more connectors electrically coupled with the electrical energy storage layer and/or with one or more of the sections of the electrical energy storage layer. The electrical connectors provide access to electrical power stored in the electrical energy storage layer.

A utility garment, such as a vest, includes a body, a pocket, and an electrical energy storage unit disposed in the pocket.

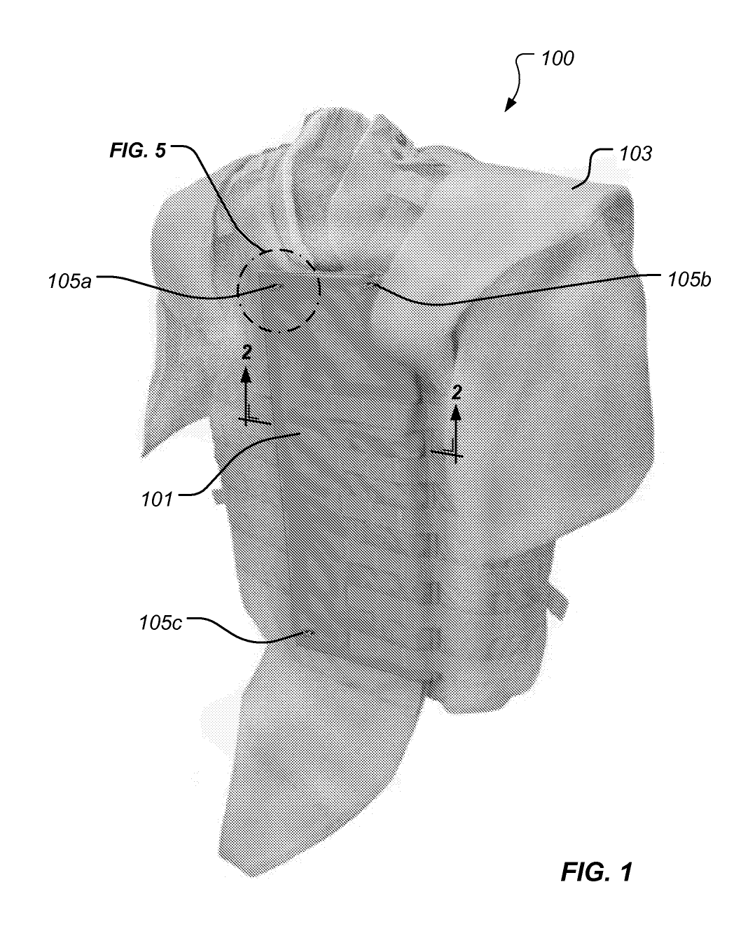

FIG. 1 depicts an illustrative embodiment of an armored garment 100 comprising a body armor 101 operatively associated with a garment 103. In FIG. 1, garment 103 takes on the form of a vest. Body armor 101, however, is also useful with a wide variety of garments other than garment 103. Moreover, body armor 101 can be operably associated with many different locations on a garment, as is discussed in greater detail herein with regard to FIG. 6.

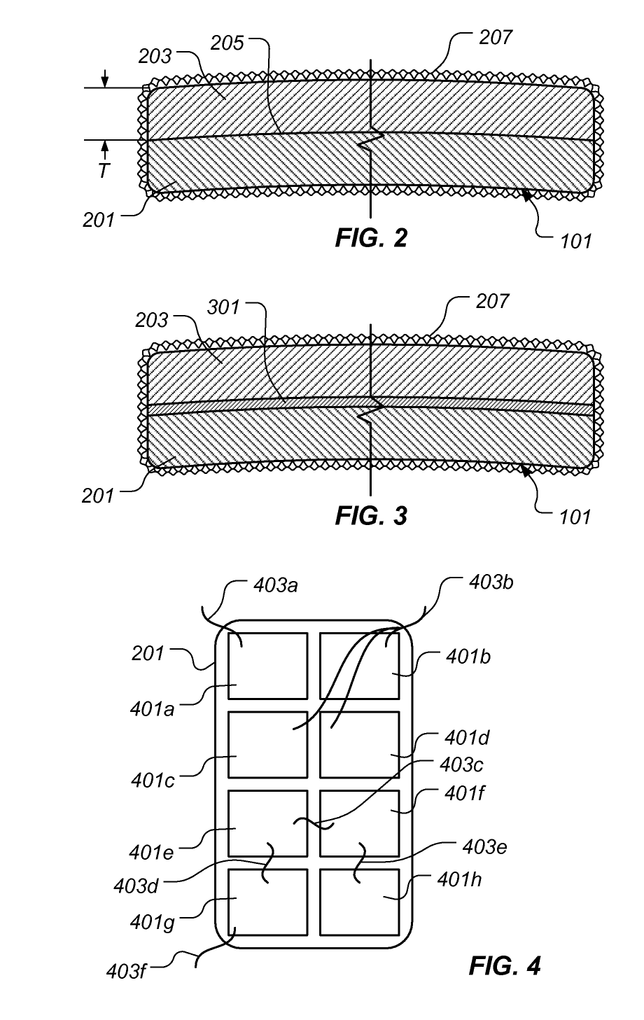

FIG. 2 depicts a stylized, cross-sectional view of a first illustrative embodiment of body armor 101, taken along a line 2-2 in FIG. 1. In the illustrated embodiment, body armor 101 comprises an armor plate 201 and an electrical energy storage layer 203 that conforms to armor plate 201. Preferably, electrical energy storage layer 203 conforms to an outer surface 205 of armor plate 201. In other words, armor plate 201 is preferably disposed between electrical energy storage layer 203 and a person wearing body armor 101 when body armor 101 is in use, such as with garment 103. In the illustrated embodiment, a protective layer 207 is disposed about armor plate 201 and electrical energy storage layer 203 to protect electrical energy storage layer 203 and to provide additional comfort for a person wearing body armor 101 when body armor 101 is in use, such as with garment 103. Preferably, protective layer 207 comprises a textile material. In one embodiment, electrical energy storage layer 203 is adhesively bonded to armor plate 203, while in an alternative embodiment, electrical energy storage layer 203 is held adjacent armor plate 203 by protective layer 207.

In one embodiment, electrical energy storage layer 203 comprises one or more adjacent rechargeable, lithium ion polymer batteries; however, other types of electrical energy storage units are contemplated by the present invention. Lithium ion polymer batteries are particularly useful in body armor 101 because can be made in thin portions and are not prone to burn when broken or otherwise compromised. Alternatively, electrical energy storage unit 109 may comprise one or more solid state, capacitive, electrical energy storage devices, such as those provided by EEstor, Inc. of Cedar Park, Tex., as described in U.S. Pat. No. 7,033,406 to Weir et al., which is incorporated herein by reference for all purposes. Such solid state electrical energy storage devices comprise calcined composition-modified barium titanate coated with aluminum oxide and calcium magnesium aluminosilicate glass. Electrical energy storage unit 203 may alternatively comprise one or more lithium ion batteries, one or more nickel-metal hydride batteries, or the like.

Preferably electrical energy storage layer 203 has a thickness T within a range of about 0.5 cm to about 3.0 cm and more preferably within a range of about 0.2 cm to about 2.5 cm. The particular thickness T of electrical energy storage layer 203 depicted in FIG. 2 is merely exemplary, as other thicknesses T are contemplated by the present invention. In FIG. 2, body armor 101 is contoured to better fit a person wearing body armor 101, such as with garment 103. Body armor 101, however, may be substantially planar or exhibit any desired configuration.

FIG. 3 depicts a stylized, cross-sectional view of a second, illustrative embodiment of body armor 101. In the illustrated embodiment, a “self-healing,” polymer layer 301 is disposed between armor plate 201 and electrical energy storage layer 203, comprising a self-healing polymer such as those produced by the Materials Research Laboratory of the University of Illinois at Champagne-Urbana, Urbana, Ill. In use, polymer layer 301 at least partially self-heals when punctured or penetrated, such as by a ballistic round. Alternatively, polymer layer 301 is disposed adjacent to armor plate 201 and electrical energy storage layer 203. Protective layer 207 is disposed about armor plate 201, polymer layer 301, and electrical energy storage layer 203, as in the embodiment of FIG. 2. Other aspects of the embodiment of FIG. 3 are substantially equivalent to the corresponding aspects of the embodiment of FIG. 2.

Body armor 101 may comprise a single electrical energy storage layer, such as electrical energy storage layer 203, which extends over a portion or substantially all of armor plate 201. Alternatively, a plurality of electrical energy storage layers, such as a plurality of electrical energy storage layers 401a-401h of FIG. 4, may be operatively associated with armor plate 201 and conform thereto. While FIG. 4 depicts a particular number and configuration of electrical energy storage layers, the scope of the present invention is not so limited. Rather the particular number and configuration of electrical energy storage layers is implementation specific.

The plurality of electrical energy storage layers 401a-401h of FIG. 4 are arranged such that each of the plurality of electrical energy storage layers 401a-401h are disposed on or adjacent to armor plate 201. In the illustrated embodiment, some of the plurality of electrical energy storage layers 401a-401h are electrically coupled, while others are not. For example, electrical energy storage layer 401a has an electrical connection, represented by lead 403a with an electrical connector 105a, shown in FIG. 1, but is not electrically connected to any of electrical energy storage layers 401b-401h. Electrical energy storage layers 401b-401d are electrically coupled with one another in parallel through a lead 403b to an electrical connector 105b of FIG. 1. Electrical energy storage layers 401e-401h are electrically coupled with one another in series through leads 403c-403e, and electrical energy storage layer 403e is electrically coupled via a lead 403f to an electrical connector 105c of FIG. 1. Other configurations, however, are contemplated by the present invention.

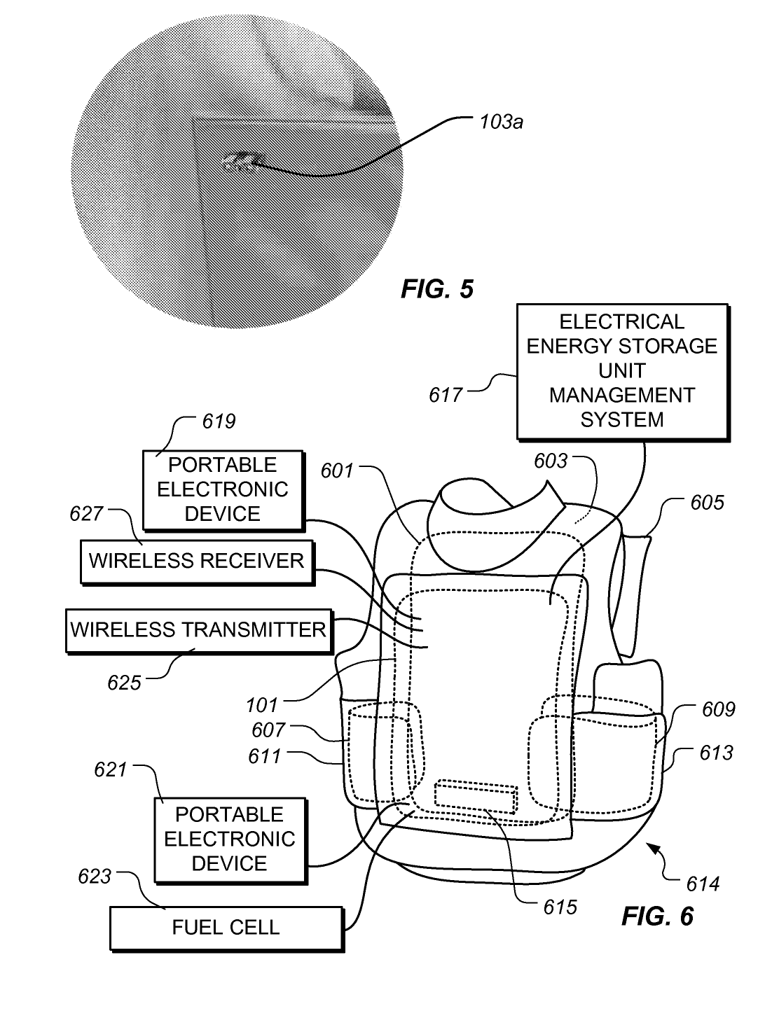

Referring again to FIG. 1, electrical connectors 105a-105c provide a way to access electrical power stored in electrical energy storage layer 203 or in one or more of electrical energy storage layers 401a-401h. Electrical connectors 105a-105c also provide electrical ports for recharging electrical energy storage layer 203 or one or more of electrical energy storage layers 401a-401h. While electrical connectors 105a-105c may have any suitable, desired configuration, and may have different configurations among electrical connectors 105a-105c, one particular configuration is shown in FIG. 5. The embodiment of connector 105a shown in FIG. 5 is a push-on, keyed, two-conductor connector.

While FIG. 1 depicts body armor 101 disposed at a front 107 of garment 103, body armor having conforming electrical energy storage layers may be disposed at many other locations of garment 103. For example, as shown in FIG. 6, a body armor 601 is disposed at a back 603 of a garment 605. In the embodiment of FIG. 6, garment 605 takes on the form of a vest. Body armor 607 and 609 are disposed at sides 611 and 613 of garment 605. Body armor 601, 607, and 609 have constructions such as the constructions depicted in and described relative to FIGS. 2-4. It should be noted that one or more body armor, such as body armor 601, 607, and 609, operatively associated with an article of clothing, such as garment 605, make up an armored article of clothing 614.

It should be noted that body armor, such as body armor 101, 601, 607, and 609, is also useful when operably associated with other articles of clothing or bodywear. For example, body armor, such as body armor 101, 601, 607, and 609, may be operably associated with helmets, other types of bulletproof vests, lower body armor, and the like.

Still referring to FIG. 6, an electrical energy storage management system 615 may be operatively associated with body armor, such as body armor 101, 601, 607, and 609, and be disposed within or attached to an article of clothing operatively associated with body armor, such as body armor 101, 601, 607, and 609. Alternatively, body armor, such as body armor 101, 601, 607, and 609, may be operatively associated with an internal or external electrical energy storage layer management system 617. Electrical energy storage management systems 615 and 617 control the recharging of electrical energy storage layers 203 and 401a-401h.

Electrical energy storage-operated, portable electronic devices, such as portable electronic devices 619 and 621, can be electrically coupled with one or more of electrical energy storage layers 203 and 401a-401h via electrical connectors, such as electrical connectors 105a-105c of FIG. 1. Such electrical energy storage-operated, portable electronic devices include, but are not limited to, communications equipment, global positioning satellite receivers, laser designators, night vision equipment, flashlights, rangefinders, and the like.

While the primary function of electrical energy storage layers 203 and 401a-401h are to provide electrical power, electrical energy storage layers 203 and 401a-401h also provide ballistic round protection to a person behind electrical energy storage layers 203 and 401a-401h in addition to armor plate 201. The soft nature of electrical energy storage layers 203 and 401a-401h, relative to armor plate 201, causes a ballistic round or fragment to spiral upon striking one of layers 203 and 401a-401h, which provides an enhancement to the ballistic resistance of armor plate 201.

A body armor comprises an armor plate, an electrical energy storage layer conforming to a surface of the armor plate, and an electrical connector operably associated with the electrical energy storage layer.

An armored article of clothing comprises an article of clothing, an armor plate operably associated with the article of clothing, an electrical energy storage layer conforming to a surface of the armor plate, and an electrical connector operably associated with the electrical energy storage layer.

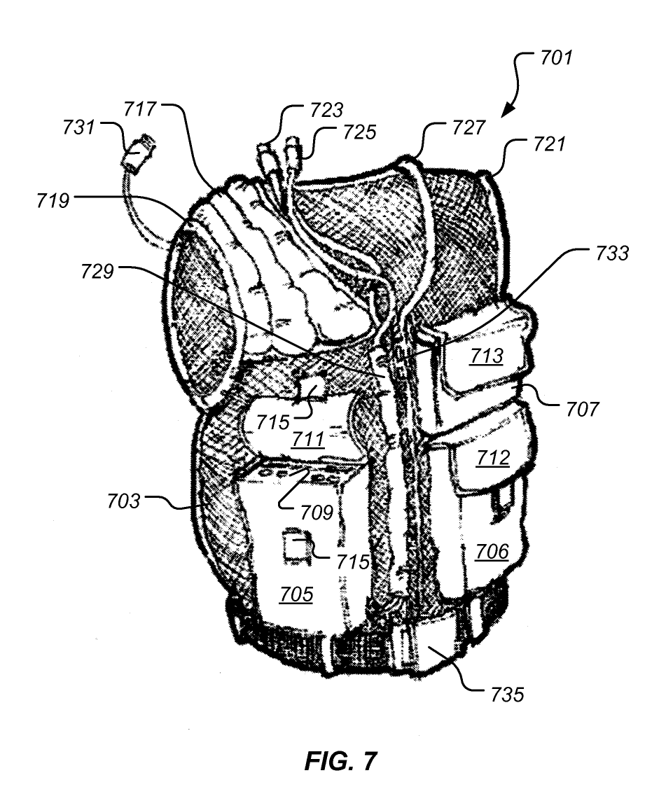

FIG. 7 depicts a front, perspective view and FIG. 8 depicts a rear, perspective view of a utility garment 701. In the illustrated embodiment, garment 701 takes on the form of a vest. Garment 701 comprises a body 703 that is preferably made from a breathable material, such as nylon mesh. Body 703, however, may comprise other materials, such as canvas or other textile materials. While garment 701 is depicted in FIGS. 7 and 8 as being sleeveless, the present invention contemplates a garment corresponding to garment 701 but having sleeves for a wearer's arms.

Garment 701 further includes one or more pouches or pockets, such as pockets 705, 706, 707, 801, and 802 attached to body 703. One or more of the pockets can be permanently attached to body 703, for example, by stitching or sewing the one or more pockets to body 703. Alternatively, one or more of the pockets can be removably attached to body 703, for example, by one or more hook-and-loop fasteners. In one embodiment, body 703 comprises a textile, non-mesh material to which the one or more pockets are attached. The pockets, such as one or more of pockets 705, 706, 707, 801, and 802, may be made from any suitable textile material. In one embodiment, one or more of the pockets is made from a mesh material.

While garment 701 may take on many different configurations that are contemplated by the present invention, pockets 705 and 706 of the illustrated embodiment of garment 701 are configured to hold portable video recorders, such as portable video recorder 709. Pocket 707 is configured in the illustrated embodiment for general use, such as to store spare video recording discs. Pockets 801 and 802 are configured in the illustrated embodiment to hold electrical energy storage units, such as electrical energy storage unit 803. In one embodiment, one or both electrical energy storage units 803 include lithium or lithium-ion batteries. In other embodiments, one or both electrical energy storage units 803 include one or more solid state, capacitive, electrical energy storage devices, such as those described herein; one or more nickel-metal hydride batteries; or the like

Moreover, garment 701 includes an electrical energy storage unit management system, such as electrical energy storage layer management system 617 of FIG. 6, which monitors the electrical storage cells in electrical energy storage units 803. In the illustrated embodiment, each of pockets 705, 706, 707, 801, and 802 include flap lids 711, 712, 713, 805, and 806, respectively, which are retained in a closed position by hook-and-loop fasteners, such as hook-and-loop fastener 715.

In the illustrated embodiment, garment 701 includes a shoulder pad 717 disposed at a shoulder 719 of body 703. Shoulder pad 717 provides cushioning between a shoulder-held video camera (not shown) and a wearer of garment 701. Shoulder pad 717 may be permanently affixed to body 703 or may be removably affixed to body 703, such as with one or more hook-and-loop fasteners. In one embodiment, garment 701 includes a second shoulder pad (not shown) corresponding to shoulder pad 719 that is disposed at a shoulder 721 of body 703. In another embodiment, shoulder pad 717 is configured to be removably attached to either shoulder 719 or 721, such as by one or more hook-and-loop fasteners.

Communication and electrical power cables are incorporated into garment 701. In the illustrated embodiment, cable 723 extends from portable video recorder 709 in pocket 705 to near a neck 727 of body 703, and cable 725 extends from electrical energy storage unit 803 to near neck 727, so that cables 723 and 725 may be electrically connected with a shoulder-held video camera (not shown). Cables 723 and 725 are retained to body 703 by a flexible, cable tunnel 729. Other cables, such as cable 731 (shown only in FIG. 7), may extend from within body 703 of garment 701 or be otherwise incorporated into garment 701.

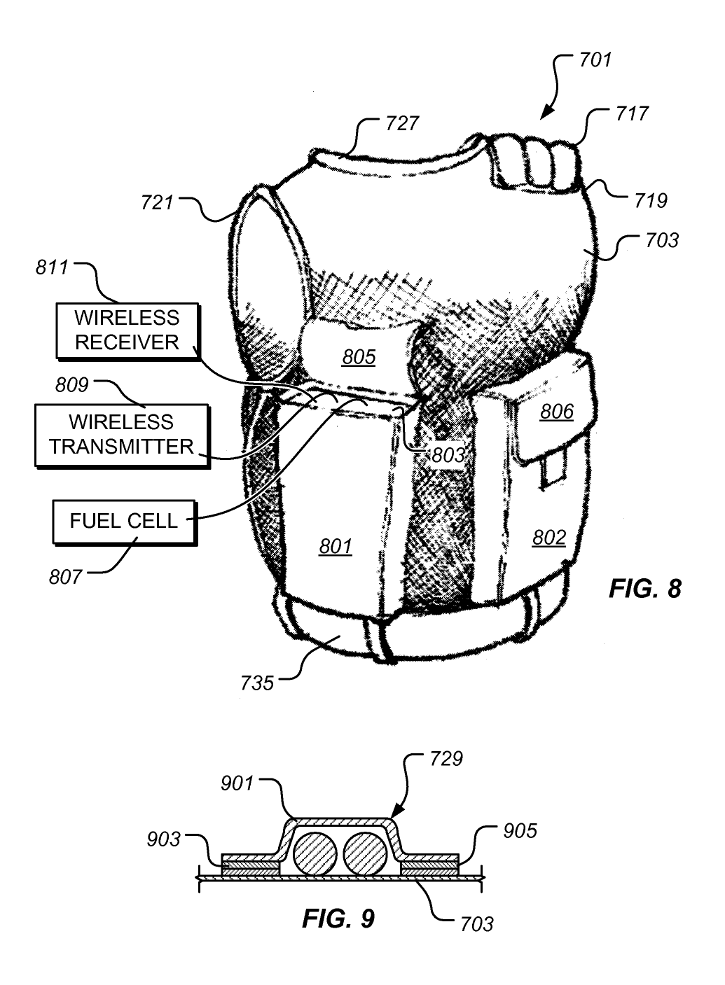

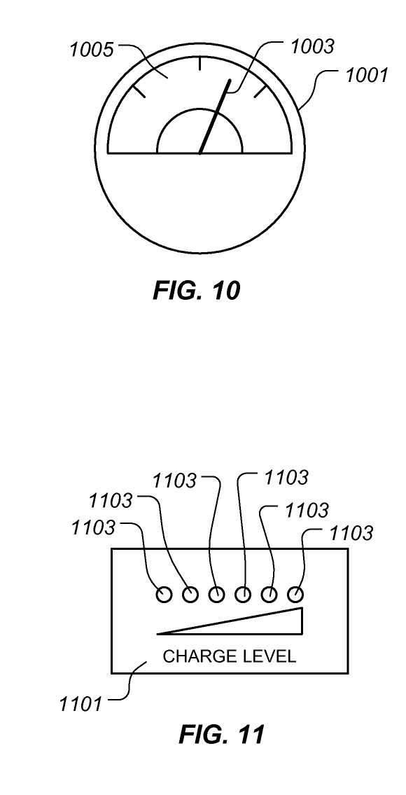

FIG. 9 depicts a stylized, cross-sectional view of one particular embodiment of cable tunnel 729. In the illustrated embodiment, cable tunnel 729 comprises a cover 901 attached to body 703 by hook-and-loop fasteners 903 and 905. Thus, cover 901 may be removed or partially removed from body 703 to install or remove cables 723 and 725 from cable tunnel 729. Alternatively, cable tunnel 729 may include only one of hook-and-loop fasteners 903 and 905, such that one side of cover 901 is permanently attached to body 703.

It should be noted that garment 701 may include more than one cable tunnel, such as cable tunnel 729. The one or more cable tunnels may be disposed at any desired location on body 703.

In the illustrated embodiment, garment 701 further includes a zipper 733 for closing body 701 and an adjustable belt 735 to provide additional support for garment 701.

It is also desirable for the embodiments disclosed herein and their equivalents to include an electric charge level indicator, such as a charge level indicator 1001 shown in FIG. 10 or a charge level indicator 1101 of FIG. 11, to indicate the level of electrical charge remaining in electrical energy storage layers 203, 401a-401h (shown in FIGS. 2 and 4, respectively), or the like; or in electrical energy storage unit 803 (shown in FIG. 8) or the like. Charge level indicator 1001 indicates a charge level of electrical energy storage unit 109 via a movable needle 1003 positioned over a fixed gage 1005. Charge level indicator 1101 indicates a charge level of electrical energy storage unit 109 via a plurality of indicator lamps 1103, such as light emitting diodes. Fewer illuminated lamps 1103 indicate a lower charge level, while a greater number of illuminated lamps 1103 indicate a higher charge level.

In certain embodiments, a fuel cell 623, shown in FIG. 6, is provided for recharging electrical energy storage layers 203, 401a-401h, or the like of body armor 101. In certain embodiments, a fuel cell 807, shown in FIG. 8, is provided for recharging electrical energy storage unit 803. It should be noted, however, that the present invention contemplates embodiments that include and omit fuel cells 623 and/or 807. It should also be noted that fuel cells 623 and 807 are merely exemplary of a means for recharging electrical energy storage layers 203, 401a-401h, or the like, and electrical energy storage unit 803 or the like.

In certain embodiments, a wireless transmitter 625, shown in FIG. 6, is provided for reporting the health and/or charge condition of electrical energy storage layers 203, 401a-401h, or the like. A wireless receiver 627, shown in FIG. 6, may be provided for receiving instructions to control electrical energy storage layers 203, 401a-401h, or the like, such as turning electrical energy storage layers 203, 401a-401h, or the like on, off, etc. In certain embodiments, a wireless transmitter 809, shown in FIG. 8, is provided for reporting the health and/or charge condition of electrical energy storage unit 803. A wireless receiver 811, shown in FIG. 8, may be provided for receiving instructions to control electrical energy storage unit 803, such as turning electrical energy storage unit 803 on, off, or the like.

Body armor of the present invention, such as body armor 101, 601, 607, and 609, as well as garments incorporating such body armor, provides many unique advantages, including, but not limited to, (1) providing a less-bulky means for powering portable electronic equipment; (2) providing a means for powering portable electronic equipment that has weight distributed about a person's body; and (3) providing a means for powering portable electronic equipment that also provides enhanced ballistic threat protection. Utility garments of the present invention provide many unique advantages, including, but not limited to, (1) providing an electrical energy storage means integrated with a garment; (2) providing cabling integrated with a garment; and (3) providing cabling integrated with a garment that is easily installed and removed from the garment.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below. It is apparent that an invention with significant advantages has been described and illustrated. Although the present invention is shown in a limited number of forms, it is not limited to just these forms, but is amenable to various changes and modifications without departing from the spirit thereof.

1. A body armor, comprising:
an armor plate;
an electrical energy storage layer conforming to a surface of the armor plate; and
a first electrical connector operably associated with the electrical energy storage layer.

2. The body armor, according to claim 1, wherein the electrical energy storage layer comprises:
at least one of a lithium ion polymer battery and a solid state, capacitive, electrical energy storage device.

3. (canceled)

4. The body armor, according to claim 1, wherein the electrical energy storage layer comprises:
a plurality of electrical energy storage sections.

5. The body armor, according to claim 4, wherein at least two of the plurality of electrical energy storage sections are electrically coupled in parallel.

6. The body armor, according to claim 5, further comprising an electrical connector operably associated with the electrically coupled electrical energy storage sections.

7. The body armor, according to claim 4, wherein at least two of the plurality of electrical energy storage sections are electrically coupled in series.

8. The body armor, according to claim 7, further comprising an electrical connector operably associated with the electrically coupled electrical energy storage sections.

9. The body armor, according to claim 1, further comprising:
a self-healing polymeric layer adjacent to the electrical energy storage layer and the armor plate.

10. An armored garment, comprising:
a garment;
an armor plate operably associated with the garment;
an electrical energy storage layer conforming to a surface of the armor plate; and
a first electrical connector operably associated with the electrical energy storage layer.

11. The armored garment, according to claim 10, wherein the electrical energy storage layer comprises:
at least one of a lithium ion polymer battery and a solid state, capacitive, electrical energy storage device.

12. (canceled)

13. The armored garment, according to claim 10, wherein the electrical energy storage layer comprises:
a plurality of electrical energy storage sections.

14. The armored garment, according to claim 13, wherein at least two of the plurality of electrical energy storage sections are electrically coupled in parallel.

15. The armored garment, according to claim 14, further comprising an electrical connector operably associated with the electrically coupled electrical energy storage sections.

16. The armored garment, according to claim 11, wherein at least two of the plurality of electrical energy storage sections are electrically coupled in series.

17. The armored garment, according to claim 14, further comprising an electrical connector operably associated with the electrically coupled electrical energy storage sections.

18. The armored garment, according to claim 10, further comprising:
a self-healing polymeric layer adjacent to the electrical energy storage layer and the armor plate.

19. The armored garment, according to claim 10, wherein the garment is a vest.

20. The armored garment, according to claim 19, wherein the armor plate and the electrical energy storage layer are disposed at least at one of a front of the vest, a back of the vest, and a side of the vest.

21-22. (canceled)

23. The armored garment, according to claim 10, further comprising an electrical energy storage management system operatively associated with the electrical energy storage layer.

24. The armored garment, according to claim 10, further comprising:
a fuel cell operably associated with the electrical energy storage layer for recharging the electrical energy storage layer.

25. The armored garment, according to claim 10, further comprising:
a wireless transmitter operably associated with the electrical energy storage layer for reporting a condition of the electrical energy storage layer.

26. The armored garment, according to claim 10, further comprising:
a wireless receiver operably associated with the electrical energy storage layer for receiving control commands for the electrical energy storage layer.

27. The armored garment, according to claim 10, further comprising:
a charge level indicator operably associated with the electrical energy storage layer.

28. A garment, comprising:
a body;
a first pocket; and
an electrical energy storage unit disposed in the first pocket.

29. The garment, according to claim 28, wherein the electrical energy storage unit comprises:
at least one of a lithium or lithium-ion battery and a solid state, capacitive, electrical energy storage device.

30. (canceled)

31. The garment, according to claim 28, further comprising:
a second pocket configured to receive a portable video recorder.

32. The garment, according to claim 28, further comprising:
a shoulder pad disposed at a shoulder of the body.

33. The garment, according to claim 28, further comprising:
a cable integrated into the garment.

34. The garment, according to claim 33, wherein the body defines a cable tunnel in which the cable is disposed.

35. The garment, according to claim 34, wherein the cable tunnel comprises:
a cover removably attached to the body.

36. The garment, according to claim 28, further comprising:
a fuel cell operably associated with the electrical energy storage unit for recharging the electrical energy storage unit.

37. The garment, according to claim 28, further comprising:
a wireless transmitter operably associated with the electrical energy storage unit for reporting a condition of the electrical energy storage unit.

38. The garment, according to claim 28, further comprising:
a wireless receiver operably associated with the electrical energy storage unit for receiving control commands for the electrical energy storage unit.

39. The garment, according to claim 28, further comprising:
a charge level indicator operably associated with the electrical energy storage unit.

40. The garment, according to claim 28, further comprising:
an electrical energy storage unit management system operably associated with the electrical energy storage unit.
